(19) United States
(12) Patent Application Publication
(10) Pub. No.: US 2026/0236020 A1
(43) Pub. Date: Aug. 13, 2026

(54) DRONE SYSTEM, COMPUTER-READABLE RECORDING MEDIUM HAVING STORED THEREIN DRONE CONTROL PROGRAM, AND DRONE CONTROL METHOD

(71) Applicant: TOHOKU UNIVERSITY, Sendai-shi, Miyagi (JP)

(72) Inventors: Maakito INOUE, Sendai-shi, Miyagi (JP); Kazuki TAKASHIMA, Sendai-shi, Miyagi (JP); Kazuyuki FUJITA, Sendai-shi, Miyagi (JP); Yoshifumi KITAMURA, Sendai-shi, Miyagi (JP)

(73) Assignee: TOHOKU UNIVERSITY, Sendai-shi, Miyagi (JP)

(21) Appl. No.: 19/243,922

(22) Filed: Jun. 20, 2025

Related U.S. Application Data
(63) Continuation of application No. PCT/JP2022/047763, filed on Dec. 23, 2022.

(51) Int. Cl. G05D 1/224; G05D 1/689; G05D 109/20; G05D 111/10

(52) U.S. Cl. CPC G05D 1/2248; G05D 1/689; G05D 2109/20; G05D 2111/17

(57) ABSTRACT

A drone system includes: a main drone including a first imaging device; a sub-drone including a second imaging device configured to capture an image of the main drone from a bird's-eye view; and a controller configured to control the main drone and the sub-drone, the controller including: a memory; a display device configured to display a bird's-eye view image captured by the second imaging device; and processor circuitry coupled to the memory and configured to display, within the bird's-eye view image, a first marker indicating a distance from the main drone.

### CROSS-REFERENCE TO RELATED APPLICATION

This application is a continuation application of International Patent Application No. PCT/JP2022/047763, filed on Dec. 23, 2022, and designated the U.S., the entire contents of which are incorporated herein by reference.

### FIELD

The embodiment(s) discussed herein is directed to a drone system, a computer-readable recording medium having stored therein a drone control program, and a drone control method.

### BACKGROUND

In recent years, drones have been used for various applications, for example, aerial photographing, inspection, spraying of agricultural chemicals, disaster relief, transportation of luggage, and the like, and the market size of drone business has been continuously expanding. In a situation in which the intention of a pilot is important, manual piloting of the drone needs to be performed, but a degree of difficulty of the piloting is significantly high. In particular, in “Beyond visual-line of sight piloting” in which a drone that is not within the field of view of a pilot is piloted relying only on an image from camera mounted on an airframe, the pilot's understandings about the surroundings (situational awareness, SA) becomes poor. The reason why the SA of the pilot becomes poor is that the viewing angle of a camera of the airframe is narrow with respect to a degree of freedom of motion of the drone, and that it is difficult for the pilot to grasp a height of the drone and a distance to an object only from the camera image. That is, it is difficult to safely fly the drone at a remote place only using information on the camera image from the airframe.

SA is classified into a state in which the state around the airframe can be perceived as level 1, a state in which the state around the airframe can be understood as level 2, and a state in which the state around the airframe can be predicted as level 3. As the level increases, the surrounding situation can be understood, and a task performed by the drone can be effectively improved. However, the current drone piloting method using only a first-person view involves many blind spots that are not captured by the camera, and even Level 1 is not satisfied in many cases.

Techniques for improving SA and supporting drone piloting are known. Patent Literature 1 discloses a method of displaying a plurality of images transmitted from a plurality of drones on a display device of a user, and displaying images of other drones in a bird's-eye view depending on selection of captured images of the plurality of drones. Patent Literature 2 discloses a bird's-eye view image display system that converts a moving device including a plurality of first cameras that capture images of surroundings at a wide angle and a second camera that captures an image in a traveling direction into an image viewed from a virtual bird's-eye view and displays the image. Patent Literature 3 discloses an image display method in which an imaging device mounted on a drone displays an image that looks like a bird's-eye view image including the drone.

In Patent documents 1 to 3, a bird's-eye view image can be obtained virtually or selectively, but the state of the drone is unable to be always grasped in real time.

The inventors of the present application have proposed a technique in which a situation of a main drone can be grasped in real time at all times by capturing the situation of the main drone in a bird's-eye view using a spatially interlocking sub-drone to acquire a third-person viewpoint, and operability of the drone is improved (for example, Non patent document 1).
[Patent document 1] Japanese Laid-Open Patent Publication No. 2019-195176
[Patent document 2] Japanese Laid-Open Patent Publication No. 2020-161895
[Patent document 3] U.S. Patent Publication No. 2019/373184
[Non-patent document] Ryotaro Temma et al., “Enhancing Drone Interface Using Spatially Coupled Two Perspectives”, Transactions of Information Processing Society of Japan (Web), Vol. 61 No. 8 Page. 1319-1332

### SUMMARY

However, in the technique proposed by the inventors of the present application in which the main drone and the sub-drone are merely spatially interlocked, a pilot can easily confirm a blind spot around the drone, but there is a problem in that the pilot is unable to accurately grasp a spatial relationship between the main drone and its surroundings, specifically, a distance from the main drone, and the like. Therefore, in a situation in which the level 2 of SA is not satisfied, for example, in a case in which an operation such as spraying of agricultural chemicals or delivery is to be performed through a drone, there is a large problem in that agricultural chemicals are unable to be sprayed to an accurate position, a target to be delivered is dropped to a position away from a recipient destination, or the target to be delivered collides with the recipient destination. In order to safely pilot a drone at a remote place, it needs to be confirmed that a pilot can confirm a blind spot and accurately recognize the drone's spatial status relative to its surroundings.

In one aspect, an object of the technique described in the present specification is to provide highly visible image display in which a pilot can confirm a blind spot around the periphery of a drone and can accurately recognize the drone's spatial status relative to its surroundings.

In one aspect, there is provided a drone system including a main drone including a first imaging device, a sub-drone including a second imaging device configured to capture an image of the main drone from a bird's-eye view, and a controller configured to control the main drone and the sub-drone, wherein the controller includes a memory, a processor coupled to the memory, and a display device configured to display a bird's-eye view image captured by the second imaging device. Furthermore, the controller may display, within the bird's-eye view image, a first marker indicating a distance from the main drone.

As one aspect, an object is to provide highly visible image display in which a pilot can confirm a blind spot around the periphery of a drone and can accurately recognize a spatial relationship between the main drone and its surroundings.

The object and advantages of the disclosure will be realized and attained by means of the elements and combinations particularly pointed out in the claims.

It is to be understood that both the foregoing general description and the following detailed description are exemplary and explanatory and are not restrictive of the disclosure, as claimed.

### BRIEF DESCRIPTION OF DRAWINGS

FIG. 1 is a block diagram schematically illustrating a configuration example of a drone system as an embodiment.

FIG. 2 is an example of images captured at substantially the same time by a main drone and a sub-drone.

FIG. 3 is a diagram for description of positions of the main drone and the sub-drone by using real-world coordinates, pixel coordinates, and In-TPV coordinates.

FIG. 4 is a diagram for description of a distance between the main drone and the sub-drone.

FIG. 5 is a diagram in which markers are displayed in the bird's-eye view image (TPV) in FIG. 2.

FIG. 6 is a diagram illustrating an example of a state in which an area image and a bird's-eye view image are displayed on a display device.

FIG. 7 is a flowchart illustrating an example of control executed by a controller.

FIG. 8 is a diagram illustrating a positional relationship in a case where there is an obstacle between the main drone and the sub-drone.

### DESCRIPTION OF EMBODIMENT(S)

Hereinafter, embodiments will be described with reference to the drawings. However, the embodiments described below are merely examples, and there is no intention to exclude the application of various modifications and techniques that are not explicitly described in the embodiments. That is, the present embodiment can be variously modified and implemented without departing from the gist thereof.

Each drawing is not intended to include only the components illustrated in the drawing, but may include other components. Hereinafter, in the drawings, parts denoted by the same reference numerals indicate the same or similar parts unless otherwise specified.

### 1. Overall Configuration

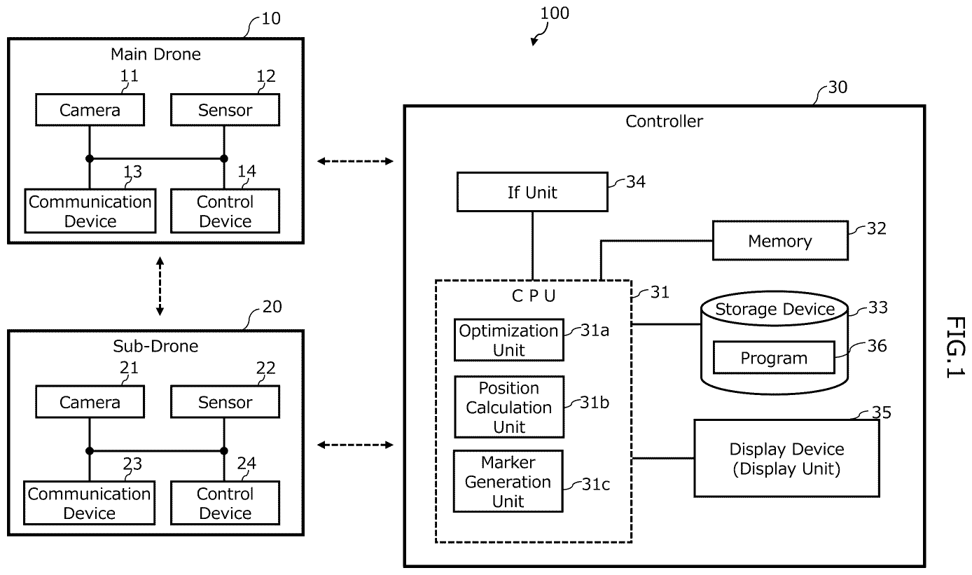

FIG. 1 is a block diagram schematically illustrating a configuration example of a drone system 100 as an embodiment. The drone system 100 includes a main drone 10, a sub-drone 20, and a controller 30. As illustrated in FIG. 1, the two drones 10 and 20 and the controller 30 are connected to each other via a network such as the Internet or Wi-Fi Direct, thereby making it possible to perform radio communication each other.

The main drone 10 is an airframe to be piloted by a user, and is an airframe that performs imaging, various kinds of work, and the like. The sub-drone 20 is set to automatically and autonomously fly and follow the main drone 10 at a position higher than the main drone 10 and at a certain distance away from the main drone 10.

The main drone 10 and the sub-drone 20 may be equipped with a device or the like that detects an obstacle or the like and automatically avoids an obstacle or the like. Here, the obstacle includes anything that hinders drone flight regardless of natural objects and artificial objects.

### [1-1. Configuration of Main Drone]

The main drone 10 includes a camera 11, a sensor 12, a communication device 13, and a control device 14.

The camera 11 captures an image of the surrounding environment (area) of the main drone 10. The image of the surrounding environment, which is captured by the main drone 10, may be referred to as an area image. The orientation and inclination (angle in the focal field direction) of the camera 11 are in any orientation and inclination. In the present embodiment, the orientation of the camera 11 substantially coincides with the traveling direction of the main drone 10, and the inclination of the camera 11 is automatically or manually set to an inclination suitable for capturing an image of an area in front of the airframe. The camera 11 is an example of a first imaging device.

The sensor 12 measures a three-dimensional position (latitude, longitude, altitude, orientation), speed, and the like of the main drone 10.

The communication device 13 transmits, to the controller 30, an area image (area information) captured by the camera 11 and the orientation (area image (FPV: first-person view) capturing direction), altitude, and speed of the main drone 10 measured by the sensor 12. It is noted that the communication device 13 may transmit the orientation and inclination of the camera 11 to the controller 30. Furthermore, the communication device 13 may transmit a signal to the sub-drone 20. The communication device 13 is an example of a communication unit of the main drone 10.

Each of the camera 11, the sensor 12, and the communication device 13 may be a movable type provided with a drive mechanism, and the angle thereof can be freely changed.

The control device 14 controls the camera 11, the sensor 12, and the communication device 13, and controls a flight mechanism (not illustrated) of the main drone 10 and a drive mechanism (not illustrated) of each of the components 11, 12, and 13 in response to a signal received by the communication device 13 from the controller 30.

### [1-2. Configuration of Sub-Drone]

The sub-drone 20 includes a camera 21, a sensor 22, a communication device 23, and a control device 24.

The camera 21 captures an image of the main drone 10 from a bird's-eye view. The orientation and inclination of the camera 21 are in any orientation and inclination. In the present embodiment, the orientation of the camera 21 substantially coincides with the traveling direction of the sub-drone 20, and the inclination of the camera 21 is automatically or manually set to an inclination suitable for capturing an image of a surrounding environment including the main drone 10. The camera 21 is an example of a second imaging device.

The sensor 22 measures a three-dimensional position (latitude, longitude, altitude, and orientation), speed, and the like of the sub-drone 20.

The communication device 23 transmits, to the controller 30, an image (bird's-eye view image) of the main drone 10, which is captured by the camera 21 from a bird's-eye view, the inclination of the camera 21, and the orientation and altitude of the sub-drone 20, which are measured by the sensor 22. It is noted that the communication device 23 may transmit the orientation of the camera 21 and the speed of the airframe to the controller 30. Furthermore, the communication device 23 may transmit a signal to the main drone 10. The communication device 23 is an example of a communication unit of the sub-drone 20.

Each of the camera 21, the sensor 22, and the communication device 23 may be a movable type provided with a drive mechanism, and the angle thereof can be freely changed.

The control device 24 controls the camera 21, the sensor 22, and the communication device 23, and controls a flight mechanism (not illustrated) of the sub-drone 20 and a drive mechanism (not illustrated) of each of the components 21, 22, and 23 in response to a signal or the like received by the communication device 23 from the controller 30.

### [1-3. Configuration of Controller]

The controller 30 includes a CPU 31, a memory 32, a storage device 33, an IF unit 34, and a display device 35. The controller 30 may be realized by an integrated device, or may be realized by a combination of separate devices such as a general-purpose computer, a display device, and an operation terminal.

The CPU 31 is a processing device (processor, processor circuitry) that performs various types of control and calculation, and realizes various functions by executing an operating system (OS) and a program (drone control program) stored in the memory 32. That is, as illustrated in FIG. 1, the CPU 31 may function as an optimization unit 31a, a position calculation unit 31b, and a marker generation unit 31c. The drone control program may be recorded on a non-transitory computer-readable storage media such as magnetic/optical disks and flash memory.

The CPU 31 is an example of a computer, and illustratively controls the operation of the entire drone system 100. The device for controlling the operation of the entire drone system 100 is not limited to the CPU 31, and may be, for example, any one of an MPU, a DSP, an ASIC, a PLD, an FPGA, and a dedicated processor. Furthermore, the device for controlling the operation of the entire drone system 100 may be a combination of two or more types of the CPU, the MPU or the DSP, the ASIC, the PLD, the FPGA, and the dedicated processor. It is noted that MPU is an abbreviation for micro processing unit, the DSP is an abbreviation for a digital signal processor, and the ASIC is an abbreviation for an application specific integrated circuit. Further, the PLD is an abbreviation for a programmable logic device, and the FPGA is an abbreviation for a field programmable gate array.

The memory 32 is a device that stores information such as various pieces of data and various programs. Examples thereof include one or both of a volatile memory such as a dynamic random access memory (DRAM) and a nonvolatile memory such as a persistent memory (PM).

The storage device 33 is a device that stores data in a readable and writable manner, and for example, a hard disk drive (HDD), a solid state drive (SSD), or a storage class memory (SCM) may be used for the storage device. The storage device 33 stores various types of information received from the main drone 10 and the sub-drone 20, values calculated by the CPU 31, and the like.

The storage device 33 may store a program 36 (a drone control program) that realizes all or a part of various functions of the drone system 100. For example, the CPU 31 of the controller 30 can realize various functions as the controller 30 by loading the program 36 stored in the storage device 33 in the memory 32 and executing the program.

The IF unit 34 is an example of a communication IF that controls connection and communication between the controller 30 and each of the main drone 10, the sub-drone 20, and a network (not illustrated). That is, the IF unit 34 may function as a communication unit of the controller 30. For example, the IF unit 34 may include an adapter conforming to local area network (LAN) such as Ethernet (registered trademark), optical communication such as Fibre Channel (FC), or the like. The adapter may support one or both of wireless and wired communication systems.

For example, the controller 30 may be communicably connected to an external device or a cloud server (not illustrated) via the IF unit 34 and a network. It is noted that a program used to control the drone system 100, including the program 36, may be downloaded from the network to the controller 30 via the communication IF and stored in the storage device 33.

The display device 35 presents an image or a video output from the controller 30 to a user. That is, the display device 35 may function as a display unit. The display device 35 may be a touch panel or may receive an input from a user. It is noted that the input from the user may be received by various input devices (not illustrated). The display device 35 can display at least the area image received from the main drone 10 and the bird's-eye view image received from the sub-drone 20 in two screens, and further display a marker indicating information on the surrounding space of the main drone 10 in the displayed bird's-eye view image.

### 2. Captured Image

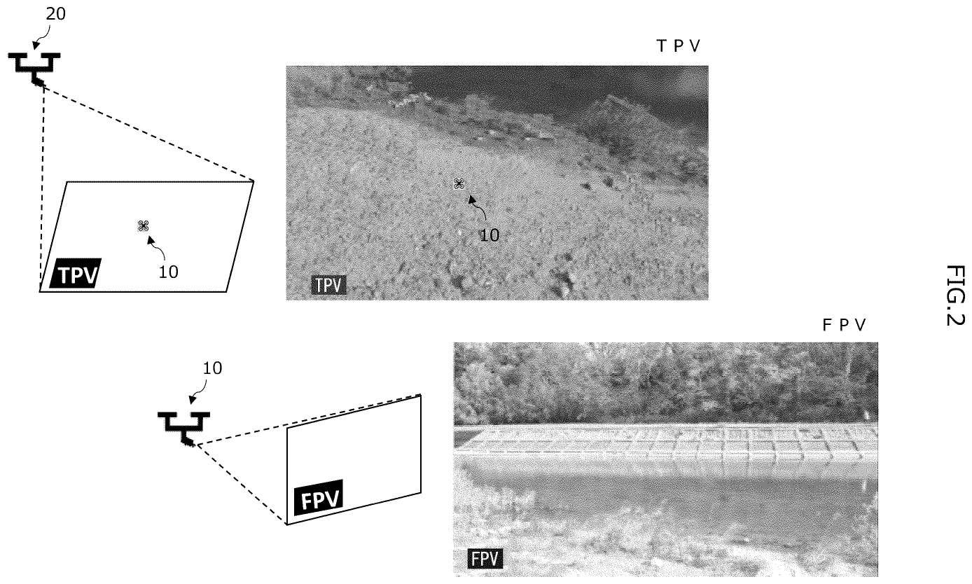

FIG. 2 is an example of an image captured by the main drone 10 and the sub-drone 20 at approximately the same time. Two frames in FIG. 2 are imaging ranges of the main drone 10 and the sub-drone 20, respectively.

The image on the right side of the imaging range of the main drone 10 is an area image (FPV) captured by the main drone 10. FPV stands for a first-person view (a first-person image), and means that it is an image from a viewpoint of the main drone. Here, the camera 11 of the main drone 10 captures an image of a certain range of the front area in the traveling direction of the main drone 10.

The image on the right side of the imaging range of the sub-drone 20 is a bird's-eye view image (TPV) captured by the sub-drone 20. TPV is an abbreviation of a third-person view (a third-person image), and means that it is an image of a viewpoint looking down on the main drone 10. The bird's-eye view image includes the main drone 10 substantially at the center thereof and the surrounding environment of the main drone 10.

In this way, the surroundings of the main drone 10 are visualized by the bird's-eye view image, so that a pilot can check a blind spot in real time. However, only these two types of images alone are not sufficient to recognize the surrounding space of the main drone 10.

In order to provide highly visible image display for accurately recognizing the spatial relationship between the main drone 10 and its surroundings, it is desirable that the sub-drone 20 can always obtain information enabling understanding and prediction of the airframe surrounding space according to the speed of the main drone 10. For this purpose, the position of the sub-drone 20 needs to be optimized. In particular, since the pilot pilots the main drone 10 while viewing the two screens of the display device 35, when a difference in distance between the main drone 10 and the sub-drone 20 increases, the two images displayed on the display device 35 are felt to be discontinuous. In this case, the burden on the pilot may be increased, and the quality of piloting the drones may deteriorate. In order to prevent this problem, a motion distance of the sub-drone 20 needs to be maximally reduced.

Furthermore, if a positional relationship between the main drone 10 and the sub-drone 20 is not appropriate, it becomes very difficult to accurately recognize the surrounding space of the main drone 10. By determining the positional relationship between the main drone 10 and the sub-drone 20 within a predetermined range, a distance from the main drone 10 and an imaging area or a traveling direction of the main drone 10 can be displayed on the screen of the display device 35 at any time.

In addition, since a relationship (which region in the bird's-eye view image is imaged by the main drone 10 as an area image) between the obtained bird's-eye view image and the area image is clear, a relationship between the bird's-eye view image and the area image becomes clearer. These types of control are implemented by the functions of the controller 30.

### 3. Functional Configuration of Controller

As illustrated in FIG. 1, the CPU 31 of the controller 30 includes an optimization unit (optimizer, optimizing processor circuitry) 31a, a position calculation unit (position calculator, position calculating processor circuitry) 31b, a marker generation unit (marker generator, marker generating processor circuitry) 31c, and a display unit (displayer, displaying processor circuitry) 35 as functional configurations in order to realize the drone control method of the present embodiment. The optimization unit 31a optimizes the arrangement of the sub-drone 20 relative to the main drone 10. The position calculation unit 31b acquires the relative position between the main drone 10 and the sub-drone 20 at the optimized position. Furthermore, the marker generation unit 31c visualizes information enabling understanding and prediction of the surrounding space of the main drone 10 on the basis of the positional relationship between the main drone 10 and the sub-drone 20. Each function will be described below.

### [3-1. Calculation of Optimal Position by Optimization Unit]

The optimization unit 31a optimizes the arrangement of the sub-drone 20 relative to the main drone 10, specifically, controls the position of the sub-drone 20, the angle of the camera 21, and the target relative angle of the sub-drone 20. The optimization unit 31a is an example of a control unit (controlling processor circuitry). The optimization unit 31a is mainly based on automatic control, and may be switchable to manual control depending on the situation.

It is important for the sub-drone 20 to satisfy the following (A) to (C) as conditions for capturing a bird's-eye view image in an appropriate range according to the speed of the main drone 10.

### <Optimal Position Conditions>

(A) The main drone 10 falls within the bird's-eye view of the sub-drone 20
(B) The area captured by the camera 11 of the main drone 10 falls within the bird's-eye view of the sub-drone 20
(C) The range in which the main drone 10 travels for a predetermined time falls Hereinafter, a method of arranging the sub-drone 20 at a position satisfying the conditions (A) to (C) will be described.

### <Optimization Method>

The determination of the arrangement position of the sub-drone 20 is designed using an optimization method.

The optimized position is calculated by the following steps:
Step 1: Define variables to be optimized
Step 2: Define a cost function
Step 3: Set variable constraints
Step 4: Output target coordinates using a primal-dual interior point method. The objective function obtained by performing Steps 1 and 2 is expressed in Equation 1.

$${min}_{P ( t ) , {θ}_{f} ( t ) , {ϕ}_{f} ( t )} \begin{matrix}( 1 ) \\ [ {w}_{1} {‖ P ( t ) - P ( t - 1 ) ‖}^{2}\end{matrix} + \begin{matrix}( 2 ) \\ {w}_{2} {{ϕ}_{f} ( t )}^{2}\end{matrix} + \begin{matrix}( 3 ) \\ {w}_{3} {( {θ}_{f} ( t ) - {θ}_{{f}_{init}} )}^{2} + {w}_{4} {‖ P ( t ) - {P}_{init} ‖}^{2} ]\end{matrix} \qquad ( Equation 1 )$$

Here, P (t): 3D target relative coordinate vector of the sub-drone at time t, Pᵢₙᵢₜ: initial (before movement) 3D target relative coordinate vector of the sub-drone, θ_{f}(t): target camera angle of the sub-drone at time t, θ_{finit}: initial (before movement) target camera angle of the sub-drone, φ_{f}(t): target relative angle of the sub-drone at time t, and w_{1 to 4}: weighting coefficient. In other words, φ_{f}(t) is a target angle of the sub-drone 20 relative to the main drone 10.
(1) surrounded in a square in Equation 1 is referred to as a first term, (2) is referred to as a second term, and (3) is referred to as a third term. The first term is introduced for the purpose of minimizing the movement of the sub-drone 20 (minimizing the movement of the point of view of the pilot), the second term is introduced for the purpose of making the orientations of the main drone 10 and the sub-drone 20 coincide with each other as much as possible, and the third term is introduced for returning to the positional relationship designated by the pilot at the end of the movement, in other words, for controlling so as not to be separated from the initial position as much as possible.

Furthermore, the constraint conditions of the objective function of Equation 1 are set (Step 3). The constraint conditions are conditions illustrated in the following i to vii. As the constraint conditions of i to vii, the suppression of an angle difference between a viewpoint and a target to be piloted, a movable range of a camera gimbal of the sub-drone 20, a presentation range of the visual field ahead in each traveling direction, a display range of a frame indicating an imaging range of the main drone 10, and the like are set.

$$i . - π / 6 \leq {ϕ}_{f} ( t ) \leq π / 6$$

$$ii . 0 \leq {θ}_{f} ( t ) \leq π / 4$$

$$iii . {y}_{f} ( t ) tan ( {θ}_{f} ( t ) \to {θ}_{\text{?}} / 2 ) - {z}_{f} ( t ) \leq 1.5 min ( 0 , {v}_{z} ( t ) )$$

$$iv . {y}_{f} ( t ) tan ( {θ}_{f} ( t ) + {θ}_{\text{?}} / 2 ) - {z}_{f} ( t ) \geq 1.5 max ( 0 , {v}_{z} ( t ) )$$

$$v . {R}_{side} ( t ) ( 1 + \frac{tan ( {ϕ}_{f} ( t ) )}{tan ( \frac{π - {θ}_{\text{?}}}{2} )} ) \leq 1.5 max ( 0 , {v}_{x} ( t ) )$$

$$vi . {R}_{side} ( t ) ( 1 + \frac{tan ( {ϕ}_{f} ( t ) )}{tan ( \frac{π + {θ}_{\text{?}}}{2} )} ) \geq 1.5 min ( 0 , {v}_{x} ( t ) )$$

$$vii . {y}_{f} ( t ) tan ( \frac{π}{2} - \frac{{θ}_{\text{?}}}{2} ) ⋆ {z}_{f} ( t ) \leq ( {y}_{f} ( t ) - y ( t ) ) tan ( {θ}_{f} ( t ) + \frac{{θ}_{\text{?}}}{2} )$$

$$\text{?} \text{indicates text missing or illegible when filed}$$

Here,

$${R}_{side} ( t ) = \frac{{z}_{f} ( t ) - {y}_{f} ( t ) tan ( {θ}_{f} ( t ) - \frac{{θ}_{\text{?}}}{2} )}{{y}_{f} ( t ) ( tan ( {θ}_{f} ( t ) + \frac{{θ}_{\text{?}}}{2} ) - tan ( {θ}_{f} ( t ) - \frac{{θ}_{\text{?}}}{2} ) )} ( \frac{{y}_{f} ( t )}{cos ( {θ}_{f} ( t ) + \frac{{θ}_{\text{?}}}{2} )} - \frac{{y}_{f} ( t )}{cos ( {θ}_{f} ( t ) - \frac{{θ}_{\text{?}}}{2} )} ) tan ( \frac{{θ}_{\text{?}}}{2} ) + \frac{{y}_{f} ( t )}{cos ( {θ}_{f} ( t ) - \frac{{θ}_{\text{?}}}{2} )} tan ( \frac{{θ}_{\text{?}}}{2} )$$

$$\text{?} \text{indicates text missing or illegible when filed}$$

is determined.

Here, as described above, φ_{f}(t) is the target relative angle of the sub-drone 20 at the time t (target angle of the sub-drone 20 relative to the main drone 10), and θ_{f}(t) is the target camera angle of the sub-drone 20 at the time t. Further, x_{f}(t), y_{f}(t), and z_{f}(t) are the target relative coordinate vectors of the respective axes of the sub-drone 20 at the time t, θ_{fvfov} is the vertical viewing angle of the camera 21 of the sub-drone 20, and θ_{fhfov} is the horizontal viewing angle of the camera 21 of the sub-drone 20. In addition, vₓ(t) and v_{z}(t) represent the speed of each axis of the main drone 10 at time t, y(t) represents the altitude of the main drone 10 from the ground at time t, and θ_{mvfov} represents the vertical viewing angle of the camera of the main drone 10.

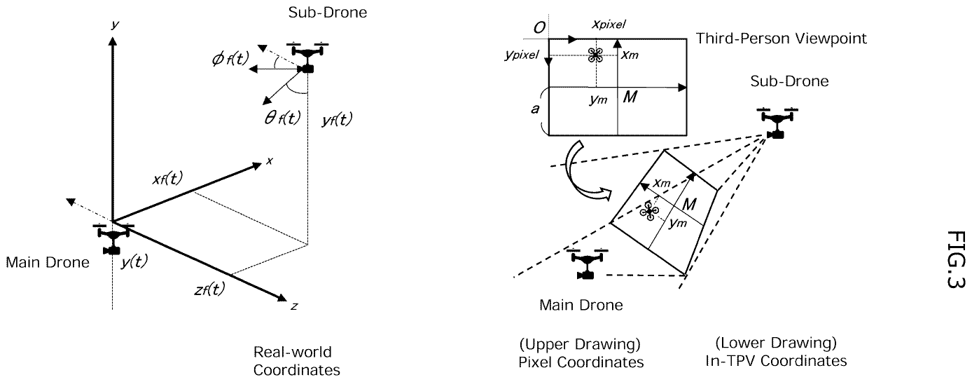

FIG. 3 illustrates three-dimensional real-world coordinates for description of the positions of the main drone 10 and the sub-drone 20. x_{f}(t), y_{f}(t), z_{f}(t), φ_{f}(t), and θ_{f}(t) are parameters (values) of real-world coordinates, respectively. In addition, an alternate long and short dash line extending from each drone in the real-world coordinates of FIG. 3 indicates the traveling direction of each drone.

Finally, under various constraints, the optimization problem is solved using the objective function of Equation 1. An optimal algorithm for solving the optimization problem is, for example, a primal-dual interior point method. The optimization unit 31a calculates the optimal arrangement position (three-dimensional target position) of the sub-drone 20, the angle of the camera 21, and the target relative angle of the sub-drone 20 by using the main dual interior point method using the current three-dimensional positions of the main drone 10 and the sub-drone 20, the angle θ_{f}(t) of the camera 21 of the sub-drone 20, the target relative angle φ_{f}(t), and the like.

The optimization unit 31a calculates a control amount by the cascade PID, and adjusts the position of the sub-drone 20, the angle of the camera 21, and the target relative angle of the sub-drone 20 based on the control amount. The optimization unit 31a performs control to move the sub-drone 20 to the determined three-dimensional target position. Furthermore, processing of updating the angle of the camera 21 and the target relative angle of the sub-drone 20 is performed at the position. In other words, the optimization unit 31a transmits, to the communication device 23 of the sub-drone 20 via the IF unit 34, a signal for controlling the main drone 10 to fall within the bird's-eye view imaged by the camera 21 of the sub-drone 20.

The optimization unit 31a may control the orientation of the sub-drone 20 according to the movement direction of the main drone 10. For example, when the main drone 10 starts to move in the right direction, the optimization unit 31a rotates the orientation of the sub-drone 20 (or the orientation of the camera 21) to an angle at which the surrounding environment in the right direction of the main drone 10 is imaged wider than the surrounding environment in the left direction. As a result, the traveling direction of the main drone 10 can be imaged in a wide range.

As described above, under the control of the optimization unit 31a, the pilot only needs to control the main drone 10, and the sub-drone 20 follows the main drone 10 so that the main drone 10 falls within a predetermined range, thereby providing a bird's-eye view image on the screen of the display device 35. Therefore, the pilot can also refer to the bird's-eye view image of the sub-drone 20 obtained by automatic control while concentrating on the operation and work of the main drone 10, thereby making it possible to greatly improve operability without performing complicated operations.

It is noted that the optimization unit 31a may manually switch the automatic follow-up control of the sub-drone 20 with respect to the main drone depending on the situation or the like. Here, the follow-up control means that the sub-drone is controlled to fly at a position where the main drone 10 falls within a predetermined range, that is, at a position where the main drone 10 can be viewed from above. It is noted that, at this time, when the sub-drone 20 is manually piloted, the control by the optimization unit 31a may be applied to the main drone 10, and the main drone 10 may automatically lead the sub-drone 20 so as to fall within the bird's-eye view of the sub-drone 20.

In addition, a function capable of canceling the automatic follow-up of the main drone 10 and the sub-drone 20 may be provided so that both drones can be manually controlled.

The optimization unit 31a arranges the sub-drone 20 and the main drone 10 within a predetermined range by the above-described method.

Furthermore, after calculating a coordinate position to be described later, the optimization unit 31a calculates an optimal position of the sub-drone 20, and arranges the sub-drone 20 at the position, thereby making it possible to arrange the main drone 10 and the sub-drone 20 in an accurate relative positional relationship.

Furthermore, the optimization unit 31a calculates the optimal angle and the optimal relative angle of the camera 21 of the sub-drone 20 at the optimized position and controls each of the angles, thereby making it possible to capture an image of the main drone 10 at the optimal position and angle.

### [3-2. Calculation of Relative Position by Position Calculation Unit]

The optimization unit 31a makes it possible to understand the airframe surrounding space of the main drone 10 when the positional relationship between the main drone 10 and the sub-drone 20, the angle of the camera 21, and the relative angle of the sub-drone 20 fall within an appropriate range.

In order to acquire information that enables understanding and prediction of the airframe surrounding space, first, a positional relationship between the main drone 10 and the sub-drone 20 needs to be acquired. The position calculation unit 31b calculates the relative position between the main drone 10 and the sub-drone 20.

There is also a method using GPS as a method of obtaining the relative position between the main drone 10 and the sub-drone 20, but the coordinates obtained by GPS have a long update frequency and a large error of 1 to 2 m or more, and are not suitable for controlling the drone. Therefore, in the present embodiment, a method of calculating the relative position by image processing is adopted.

First, the position calculation unit 31b detects the main drone 10 from the bird's-eye view image. The detection method such as color detection may identify the main drone 10 using a well-known image processing library such as OpenCV. Furthermore, the position calculation unit 31b corrects the bird's-eye view image. The image correction may be performed by using a known method such as a camera matrix and a distortion matrix obtained in advance using Zhang's camera calibration method.

FIG. 3 illustrates pixel coordinates and In-TPV coordinates for description of the positions of the main drone 10 and the sub-drone 20. On the basis of the corrected image, the position calculation unit 31b calculates the pixel coordinates xₚᵢₓₑₗ, yₚᵢₓₑₗ of the main drone 10 appearing in the camera 21 of the sub-drone 20 using image recognition. Next, the position calculation unit 31b calculates the In-TPV coordinates xₘ(t), yₘ(t) with an image center M of the main drone 10 as the origin from the distances using the pixel coordinates xₚᵢₓₑₗ, yₚᵢₓₑₗ of the main drone appearing in the image. Furthermore, calculation is performed by converting the In-TPV coordinates into a distance using coordinates x_{f}(t), z_{f}(t) of the real space (real world). As illustrated in FIG. 3, the coordinates of the position of the main drone can be expressed by real-world coordinates, In-TPV coordinates, and pixel coordinates.

<Derivation of Distance xₘ, yₘ of In-TPV Coordinates>

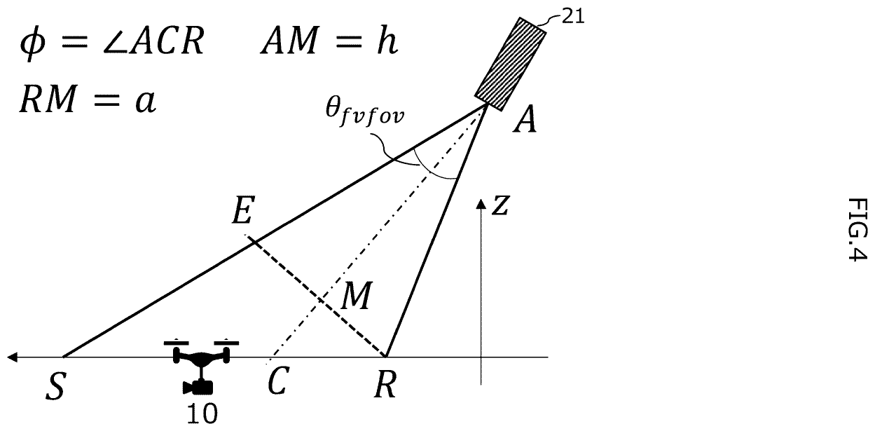

In deriving the coordinates xₘ, yₘ, a spatial plane on which the main drone 10 and the sub-drone 20 are present is represented by a coordinate system. FIG. 4 is a diagram for description of a distance between the main drone 10 and the sub-drone 20. Intersection points where a horizontal plane on which the main drone 10 is present intersects a line segment forming a vertical viewing angle θ_{fvfov} of the camera 21 of the sub-drone 20 are defined as S and R, and the position of the camera 21 (for example, the lens position) is defined as A, thereby determining a line segment AS and a line segment AR. When the line segment AS and the line segment AR are compared with each other, a point E is taken on the longer line segment AS such that the shorter line segment AR has the same distance from the point A. At this time, an isosceles triangle AER is formed. Considering a perpendicular line from the position A of the camera 21 to the isosceles triangle AER, an intersection point of the perpendicular line from A to the isosceles triangle AER is defined as M, and an intersection point between an extension line of AM and the horizontal plane on which the main drone 10 is present is defined as C. Here, the coordinate system of each position is considered with the intersection point M as the origin (center). A perpendicular line AC indicates a viewpoint direction of the camera 21 (the center direction of the vertical viewing angle θ_{fvfov}).

Conversion from the pixel coordinates xₚᵢₓₑₗ, yₚᵢₓₑₗ to the In-TPV coordinates xₘ(t), yₘ(t) is expressed by the following Equations.

$${x}_{m} ( t ) = 2 h tan \frac{{θ}_{\text{?}}}{2} ( \frac{{y}_{pixel}}{{y}_{max}} - \frac{1}{2} ) . \qquad ( Equation 2 )$$

$${y}_{m} ( t ) = 2 a ( \frac{1}{2} - \frac{{x}_{pixel}}{{x}_{max}} ) \qquad ( Equation 3 )$$

$$\text{?} \text{indicates text missing or illegible when filed}$$

Here, xₘₐₓ, yₘₐₓ are maximum values of pixel coordinates, respectively.

Variables h and a in Equations 2 and 3 are expressed by the following Equations.

$$h = \frac{{y}_{f} ( t )}{cos ( {θ}_{f} ( t ) - {θ}_{\text{?}} / 2 )} cos {θ}_{\text{?}} \qquad ( Equation 4 )$$

$$a = \frac{{y}_{f} ( t )}{cos ( {θ}_{f} ( t ) - {θ}_{\text{?}} / 2 )} sin {θ}_{\text{?}} . \qquad ( Equation 5 )$$

$$\text{?} \text{indicates text missing or illegible when filed}$$

Here, h=AM and a=RM. y_{f}(t) is the relative altitude, and θ_{fvfov} is the vertical viewing angle of the camera 21.

Among these, y_{f}(t) is obtained from altitude information of each of the sensor 12 of the main drone 10 and the sensor 22 of the sub-drone 20, θ_{fvfov} is known information of the camera 21, and h and a can also be easily calculated from these pieces of information.

<Derivation of Distance x_{f}(t), z_{f}(t) on Real-world Coordinates>

In order to grasp the actual relative positions of the main drone 10 and the sub-drone 20, the In-TPV coordinates need to be converted into real-world coordinates. The position calculation unit 31b converts a distance obtained from the In-TPV coordinates xₘ, yₘ into a distance obtained from the real-world coordinates (real space, real world) x_{f}(t), z_{f}(t) by using the following Equations.

$${x}_{f} ( t ) = \frac{{y}_{m} ( t ) ( h sin ϕ + a cos ϕ )}{{x}_{m} ( t ) cos ϕ + h sin ϕ} \qquad ( Equation 6 )$$

$${z}_{f} ( t ) = \frac{{x}_{m} ( t ) ( h + a sin ϕcos ϕ ) - ah {cos}^{2} ϕ}{{x}_{m} ( t ) cos ϕ + h sin ϕ} + h cos ϕ \qquad ( Equation 7 )$$

h and a are as defined in Equations 4 and 5.

In Equations 6 and 7, φ can be expressed by the following Equation.

$$ϕ = \frac{π}{2} - {θ}_{f} ( t ) . \qquad ( Equation 8 )$$

Here, φ=∠ACR. φ is an angle with respect to the perpendicular line AC, in other words, φ is an angle formed by the viewpoint direction of the camera 21 and the horizontal plane on which the main drone 10 is present. φ=∠ACR is obtained from the inclination (angle) of the camera 21 transmitted from the sub-drone 20.

In other words, the distance obtained from the real-world coordinates (real space, real world) x_{f}(t), z_{f}(t) is a distance in the horizontal direction between the main drone 10 and the sub-drone 20, and the distance obtained from the real-world coordinates x_{f}(t), z_{f}(t) is calculated using the pixel coordinates, the angle φ of the sub-drone 20 relative to the perpendicular line AC of the camera 21, the vertical viewing angle θ_{fvfov} of the camera 21, and the altitude difference y_{f}(t) between the main drone 10 and the sub-drone 20.

In deriving Equations 2 to 8, the pixel coordinates of the main drone 10 are obtained by image recognition processing, and the relative altitude y_{f}(t) between the drones is obtained by the sensors 12 and 22. In addition, the inclination of the camera 21 (target camera angle θ_{f}(t)) and the vertical viewing angle θ_{fvfov} of the camera 21 are known. In this manner, the distance obtained from the pixel coordinates xₚᵢₓₑₗ and yₚᵢₓₑₗ and the distance (relative distance) obtained from the real-world coordinates (real space, real world) x_{f}(t), z_{f}(t) can be easily calculated with few variables without complicated calculation.

When the coordinates of the main drone 10 and sub-drone 20 are determined, the optimization unit 31a adjusts the positions so that the main drone 10 and sub-drone 20 have an optimal relative positional relationship. Furthermore, after achieving the optimal relative positional relationship, the optimization unit adjusts the angle θ_{f}(t) of the camera 21 and the target relative angle φ_{f}(t) to the optimal angles.

### [3-3. Marker Generation Unit]

Information enabling understanding and prediction of the airframe surrounding space is visualized on the basis of the distance x_{f}(t), z_{f}(t) calculated by the position calculation unit 31b. The marker generation unit 31c generates a marker to be displayed on the bird's-eye view image.

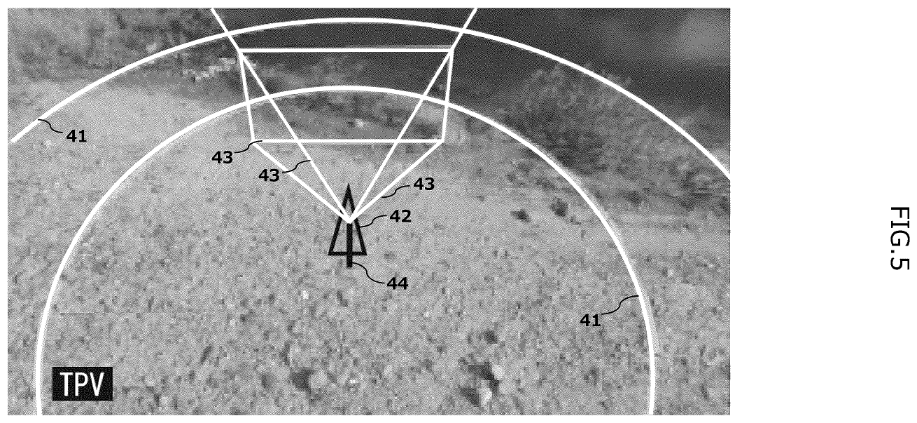

FIG. 5 is a view in which markers are displayed in the bird's-eye view image (TPV) in FIG. 2. In FIG. 5, a triangular marker 42 indicating the orientation of the main drone 10, a vertical line marker 44 indicating the height, a frustum marker 43 indicating the imaging area of the main drone 10, and a circular marker 41 indicating a distance from the main drone 10 (for example, a radius of 5 m and a radius of 8 m) are superimposed and displayed on the bird's-eye view image (TPV). Such highly visible images allow a pilot to quickly understand and predict the airframe surrounding space.

In the present embodiment, the pilot uses augmented reality (AR) to display space information around the drone by superimposing a marker on the bird's-eye view image. For the superimposition display in AR, for example, a cast shadow method may be used.

In order to understand the situation of the airframe when an image is captured, information on the orientation of the main drone 10 and the altitude of the main drone 10 needs to be provided.

As an example, the orientation (heading direction) of the main drone 10 is displayed using the triangular marker (second marker) 42. A method using a triangle imposes a lower cognitive load than a method using an arrow. The triangle is desirably an isosceles triangle, and the direction pointed by the apex angle of the isosceles triangle is the heading direction of the main drone 10.

Furthermore, in a case where the main drone 10 is not in the hovering state and is moving, the size of the triangular marker 42 may be changed according to the speed of the main drone 10. It is noted that the marker is not limited to the triangular marker 42, and any marker may be used as long as it allows a user to intuitively understand the heading direction.

The altitude of the main drone 10 is displayed by the vertical line marker (fourth marker) 44. The vertical line is a straight line that connects a reference plane to a specific portion of the main drone 10 (for example, the center of gravity of the main drone 10), and the reference plane and the vertical line are perpendicular to each other. That is, the upper end of the straight line represents the position of the main drone 10. The reference plane is, for example, the ground surface, and is not limited to altitude, and may be a distance (height) of a structure or the like under the vertical direction, which is closest to the main drone 10. A distance between these structures and the like is obtained by the sensor 12 and the like.

Furthermore, the vertical line marker 44 may display a predetermined scale, or may change in color such as becoming a red marker in a case where the distance becomes shorter than a certain threshold value. In addition, numerical information regarding the altitude may be displayed in the TPV. It is noted that the vertical line marker 44 is not limited to a vertical line, and any vertical line marker may be used as long as it can be intuitively understood as information regarding altitude.

In this example, the imaging range of the main drone 10 is displayed using the quadrangular frustum marker (third marker) 43. The bottom of the quadrangular frustum represents the imaging range of the main drone 10, and the apex represents the position of the main drone 10. In other words, the base of the quadrangular frustum is a quadrangular frame of the area image (FPV) captured by the main drone 10, which will be described later with reference to FIG. 5.

Furthermore, the quadrangular frustum marker 43 is the imaging area from the camera 11, and the space imaged by the camera 11 may be represented by lines connecting the camera 11 to the four corners of the quadrangular frustum marker 43.

It is noted that the lines connecting the camera 11 to the four corners of the quadrangular frustum marker 43 do not need to be displayed.

A very important piece of information about the main drone 10 is a distance from the main drone 10.

Since it is difficult for the pilot to grasp the actual positional relationship and angle between the main drone 10 and the sub-drone 20 from the bird's-eye view image itself, it is easy for the pilot to misidentify, in the bird's-eye view image, how far the main drone 10 is from what appears in the bird's-eye view image. According to the present embodiment, since the pilot can grasp the position of the main drone in the real-world coordinates, the pilot can accurately grasp how far an object or a place shown in the image is from the main drone 10.

The distance from the main drone 10 is indicated by the circular marker (first marker) 41 having the main drone 10 as a central portion thereof.

The circular marker 41 can be displayed at any distance from the main drone 10, which is selected by the pilot.

Furthermore, for example, a plurality of distances such as 3 m and 5 m can be displayed using a plurality of circular markers 41.

It is noted that the marker 41 indicating the distance from the main drone 10 is not limited to a circular marker, and any marker may be used as long as the distance from the main drone 10 can be intuitively grasped.

In the related method, it is difficult to grasp an accurate position (distance) from the main drone 10 to a surrounding target object. For example, there are problems that, for example, when agricultural chemicals are sprayed, it is not possible to spray the agricultural chemicals at a targeted location, and when goods are delivered, it is not possible to deliver the goods to a target person at the optimal position. However, in the embodiment of the present application, since the positional relationship between the main drone 10 and the sub-drone 20 falls within a predetermined range, and the positions of the main drone 10 and the sub-drone 20 are set in the coordinate system, thereby making it possible to display the accurate marker 41 indicating the distance from the main drone 10.

Furthermore, in addition to understanding the current distance of the surrounding space of the main drone 10, it is desirable to be able to predict the position of the main drone 10 after a lapse of a predetermined time. In order to predict the position of the main drone 10, not only a distance between the main drone 10 and an object in the surrounding environment but also information on the expected arrival position of the main drone 10 needs to be provided.

The controller 30 receives images from the main drone 10 and the sub-drone 20 in real time. However, since humans need time to make a determination known as a selective reaction time, the expected arrival position of the drone 10 needs to be within a range that takes into account the pilot's selective reaction time.

The expected arrival position of the main drone 10 is displayed as a circular marker (first marker) having the main drone 10 as a central portion thereof, similarly to the marker 41 that indicates a distance, from the perspective of cognitive load and in consideration of a drone that is movable in all directions. In the present embodiment, a traveling direction destination L indicated by the following Equation is defined as a radius of a circle.

$$L = 1.5 [ s ] \times v ( t ) \qquad ( Equation 9 )$$

v(t) is the speed of the main drone 10 at time t, and 1.5 [s] is a value proposed in the literature (Hick, W. E. [Quarterly Journal of Experimental Psychology 1952]) as the selective reaction time.

The expected arrival position of the main drone 10 may be displayed in a plurality of circles by setting a plurality of times t. In addition, in a case where the main drone 10 moves not only in the horizontal direction but also with a vertical direction component, a spherical marker corresponding thereto may be used, or the estimated position at the time t may be displayed in the TPV by a marker of the drone or the like, or a movement trajectory or the like may be indicated.

The various markers 41 to 44 in the TPV may be displayed only when the markers need to be provided, using a function of selecting whether to display the markers in the TPV. Conversely, if there are a plurality of markers, it may be difficult for the pilot to see the markers. In this case, the pilot may be allowed to select only the markers he or she wants to display, thereby allowing the pilot to proceed with the operation without stress.

Alternatively, the circular marker indicating the distance and the vertical line marker indicating the height may be automatically displayed in a case where the circular marker 41 and the vertical line marker 44 become equal to or less than a predetermined threshold value from the safety of the main drone 10 and the periphery thereof.

It is noted that, in order to display space information in AR, the real-world coordinates need to be converted into pixel coordinates. The position calculation unit 31b calculates the values of the pixel coordinates using inverse functions of Equations 6 to 8. The information to be drawn using a cast shadow method may be obtained by substituting the altitude of the sub-drone 20 into y_{f}(t) in Equations 4 and 5. Furthermore, in the case of drawing concentric circles, position coordinates of four points equidistant points from the main drone 10 are converted into pixel coordinates, and a perspective projection transformation matrix using these four points is applied to a perfect circle.

### [3-4. Display Unit]

The display unit 35 of the controller 3 displays an area image and a bird's-eye view image on the screen of the display device 35. The display unit 35 further displays the triangular marker 42, the vertical line marker 44, the frustum marker 43, and the circular marker 41 generated by the marker generation unit 31c in the bird's-eye view image.

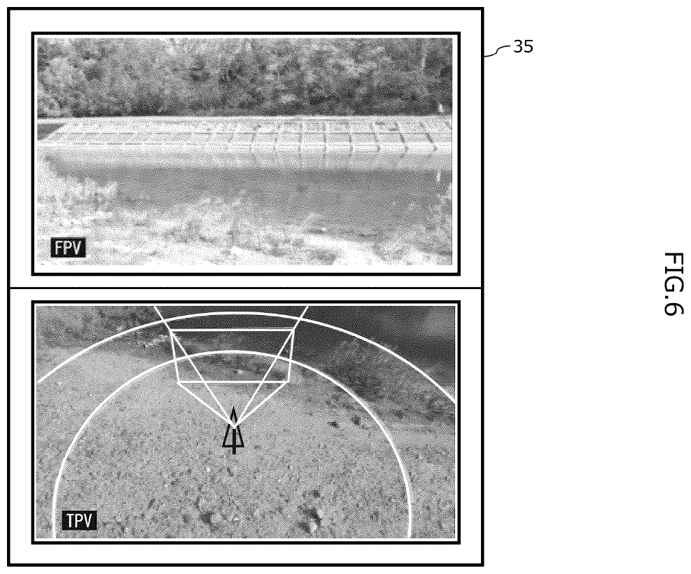

FIG. 6 is a diagram illustrating an example of a state in which FPV and TPV with markers are displayed on the display device 35. In the present embodiment, two types of images are arranged vertically. Here, the upper side is an area image, and the lower side is a bird's-eye view image with markers. The pilot is less likely to be confused when the images are arranged vertically than when the images are arranged horizontally and parallel to each other. The display device 35 may display two images vertically on one screen, or may have a structure including two screens connected to each other by a hinge mechanism and capable of tilting the upper and lower screens to the front side of the pilot.

### 4. Operation of Drone Control

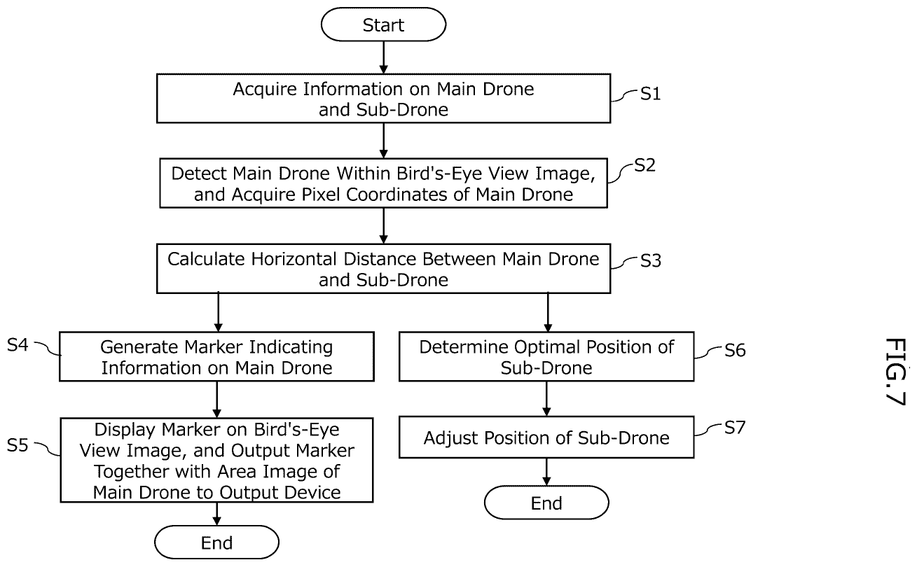

FIG. 7 is a flowchart illustrating an example of control executed by the controller 30. This flow is started when the main drone 10 and the sub-drone 20 take off (for example, when an ON signal is received from an activation switch), and is executed by the controller 30 until both drones 10 and 20 finish flight thereof (for example, until an OFF signal is received from the activation switch).

As illustrated in FIG. 7, the CPU 31 of the controller 30 acquires information on the main drone 10 and the sub-drone 20 via the IF unit 34 (step S1). The information on the main drone 10 is an area image (area information) captured by the camera 11 of the main drone 10, the orientation, altitude, and speed of the airframe itself, which are measured by the sensor 12. The information on the sub-drone 20 is the image (bird's-eye view image) of the main drone 10, which is captured by the camera 21 from a bird's-eye view, the inclination of the camera 21, and the orientation and altitude of the airframe itself, which are measured by the sensor 12.

After the main drone 10 starts flight thereof, the sub-drone 20 starts flight thereof following the main drone 10, and when reaching the target position, the sub-drone 20 automatically moves to a predetermined position at which the main drone 10 can be kept within the bird's-eye view by the above-mentioned method.

The position calculation unit 31b of the controller 30 detects the main drone 10 in the bird's-eye view image and obtains the pixel coordinates of the main drone 10 (step S2). The pixel coordinates are a coordinate system having the point M as a central portion thereof, which is illustrated in FIG. 3.

Subsequently, the position calculation unit 31b calculates a horizontal distance between the main drone 10 and the sub-drone 20 (step S3). The horizontal distance is a distance x_{f}(t), z_{f}(t) between the drones in real-world coordinates, and a distance x_{f}(t), z_{f}(t) in real-world coordinates is calculated using the angle φ of the sub-drone 20 relative to the perpendicular line AC of the camera 21, the vertical viewing angle θ_{fvfov} of the camera 21, and the altitude difference y_{f}(t) between the main drone 10 and the sub-drone 20.

After step S3, two types of processing that can be executed simultaneously in parallel are performed. First, marker generation processing, which is the flow on the left side, will be described. The marker generation unit 31c generates a marker that indicates the information of the main drone 10 to be displayed in the bird's-eye view coordinates (step S4). The markers include the triangular marker 42 indicating the orientation of the main drone 10, the circular marker 41 indicating the distance from the main drone 10, the frustum marker 43 indicating the imaging area of the main drone 10, and the vertical line marker 44 indicating the height of the main drone 10.

In the display unit 35, the marker generation unit 31c superimposes and displays the generated marker on the bird's-eye view image of the sub-drone 20 and displays (outputs) the generated marker on the screen of the display device 35 together with the area image of the main drone 10 (step S5).

The position control processing of the sub-drone 20, which is the other processing after step S3, will be described. The optimization unit 31a calculates the optimal position of the sub-drone 20 (step S6). The calculation of the optimal position is performed using the objective function expressed by Equation 1 under constraint conditions i to vii that realize the above-mentioned optimal position conditions (A) to (C). The optimization unit 31a calculates the optimal arrangement position (three-dimensional target position) of the sub-drone 20, the angle of the camera 21, and the target relative angle of the camera by using a primal-dual interior point method using the current three-dimensional positions of the main drone 10 and the sub-drone 20, the angle of the camera 21 of the sub-drone 20, the target relative angle of (t), and the like.

The optimization unit 31a adjusts the position of the sub-drone 20 based on the calculated control amount (step S7). The optimization unit 31a transmits a control signal to the communication device 23 of the sub-drone 20 via the IF unit 34, and the control device 24 of the sub-drone 20 moves the airframe to a three-dimensional target position. Then, the angle, the target, and the relative angle of the camera 21 are adjusted to optimal angles at the position.

### 5. Experimental Example

### [5-1. Experimental Content]

Experiment was conducted to verify how the drone system 100 of the present embodiment improved the SA of a pilot.

In the experiment, in order to reduce the influence of learning and training effects of drone piloting as much as possible, the piloting was performed on 6 novice participants whose piloting time of the drone was 1 hour or more and less than 10 hours.

The experiment was performed outside a densely populated area. In the experiment, a tent was set up to protect the pilot from direct sunlight, and the pilot piloted the drone in the tent. Piloting the drone was performed in visual line of sight flight (this is because it is prohibited by law for an unskilled person to fly a drone beyond visual line of sight.).

In the experiment, DJI Mavic 2 pro was used as a main drone, and Parrot anafi 4K was used as a sub-drone. In the experiment, the drone moved in a direction different from the orientation of the camera (movement into a blind spot of the FPV), and two types of tasks requiring detailed position recognition were performed. The tasks included 1. Nose-in-Circle task (a task of moving the drone around a subject while showing the subject in the FPV of the camera), which makes it easy to determine whether the pilot can understand a situation around an airframe (level 2 of SA), and 2. Fast-positioning task (a task of moving the drone between a plurality of poles as quickly as possible), which makes it easy to determine whether the pilot can predict the situation around the airframe (level 3 of SA).

In the Nose-in-Circle task, the main drone continues to circle around the subject while maintaining a distance of 5 m from the subject.

As independent variables, three methods including FPV only, FPV plus a dynamically arranged third-person viewpoint without AR (AutoTPV), and the drone system 100 method of the present embodiment (AR-BirdView) were used.

The evaluation was made by an average error distance between the subject and the main drone.

In the fast-positioning task, the main drone moves between three types of poles A, B, and C. The poles were arranged such that the pole B was disposed at a position 20 m away from the pole A, and the pole C was disposed at a position 20 m away from the pole B at a right angle relative to a pole A-B line.

In this task, the main drone was instructed to move as fast as possible and stop at a position 5 to 8 m away from the pole. In addition, in order to reduce the learning effect, three routes were prepared for visiting of the poles A to C: A→B→C→B→A, B→C→B→A→B, and C→B→A→B→C, and the task was performed using a different route for each interface.

As independent variables, three interface methods were used, such as FPV only, AR-Top View in which AR superimposition display (displays a radial distance from the main drone serving as the center) was performed in a third-person viewpoint from directly above, and a method of the present embodiment (AR-BirdView).

In the experiment, the evaluation was performed using quantitative evaluations such as a total average time for the drone to move along the above routes, an average ratio (a task success rate) at which the drone was able to stop within a designated range (within 5 to 8 m from the pole), and a motion distance of the main drone for completion of the task.

The pilots practiced each of the three piloting interfaces for about 10 minutes. The pilots were also trained to perform turning of the drone and to cause the drone to turn around in addition to straight movement of the drone. When the pilots were accustomed to each interface, they moved on to the respective experimental tasks.

The Nose-in-Circle task was practiced for 5 to 10 minutes for each pilot, and then the Nose-in-Circle task experiment was conducted. After that, route confirmation and practice for the high-speed movement task were conducted for 5 to 10 minutes for each pilot, and then the high-speed movement task experiment was conducted. In addition, in each case, the pilots were asked to fill in a questionnaire on the extent to which they were able to recognize the situation around the main drone (space recognition), the extent to which they were able to understand a positional relationship between the main drone and a subject or a pole (space understanding), how easy it was to plan the flight of the main drone (operation planning), a degree of anxiety about the direction of movement (anxiety), and a degree of concentration that is needed to pilot the drone (concentration), and subjective data from the pilots was also acquired.

### [5-2. Results]

### [5-2-1. Nose-in-Circle Task]

In the Nose-in-Circle task, when the interface was only the FPV, the pilot estimated a distance based on the size of a subject appearing on the screen from the camera of the main drone. In addition, in the AutoTPV, the distance is estimated based on a distance between the main drone and the sub-drone in addition to the video of the camera of the main drone. In the AR-BirdView of the present embodiment, in addition to the video of the camera of the main drone, the distance is determined based on a distance between grid lines and a pole displayed in the bird's-eye view image from the sub-drone.

The average error of the distance between the subject and the main drone for each interface was collected (measured).

As a result, when the interface was only the FPV, an average error of about 1.28 m occurred. In addition, when the interface was the AutoTPV, an average error of around 0.85 m occurred. In the interface of the present embodiment, the average error range was within about 0.37 m.

In addition, when the pilots were asked about a degree of load on their concentration when piloting was performed in each interface, the FPV was found to be the highest load, and in particular, when conversion into scores was performed, the space recognition, the space understanding, the operation planning, and the anxiety were worse than the AutoTPV and the method of the present embodiment by a factor of two or more. On the other hand, in the comparison between the load of the AutoTPV and the load of the interface of the present embodiment, the load of the interface of the present embodiment was substantially the same in terms of scores, but the load of the interface of the present embodiment was significantly excellent in terms of space understanding and operation planning.

### [5-2-2. Fast-positioning Task]

In the fast-positioning task, when the interface is only the FPV, the pilot needs to determine the movement direction only by the video of the traveling direction captured by the main drone itself. Furthermore, in the AR-Top View, in addition to the video of the camera of the main drone, a video of the main drone viewed from directly above is obtained. In the AR-BirdView of the present embodiment, in addition to the video of the camera of the main drone, the sub-drone was able to obtain a video in which a grid line indicating the distance is displayed on the video mainly presented by the sub-drone in the direction of a destination to which the main drone moves.

The total average time for movement along the route in the high-speed movement task was about 33 to 34 seconds on average when only the FPV was used, and about 35 to 36 seconds when the AR-Top View was used. On the other hand, in the method of the present embodiment, movement could be performed in the shorted time of 31 to 32 seconds.

The task success rate was about 75% when only the FPV was used, about 71% when the AR-Top View was used, and about 88% when the method of the present embodiment was used, which indicates that the success rate is greatly improved when the method of the present embodiment was used.

In addition, the motion distance to complete the task was about 103 m when only the FPV was used, about 101 m when the AR-Top View was used, and about 91 m when the method of the present embodiment was used, which indicates that the method of the present embodiment enables efficient flight.

In the questionnaire asking the pilots about a degree of load on concentration and other aspects during the high-speed movement task, similarly to Nose-in-Circle task, the load was the highest in the case of the FPV. In particular, when conversion into scores was performed, the results for the space recognition, the space understanding, the operation plan, and the anxiety were 2 to 4 times or more worse than the present embodiment. In AR-Top View and the method of the present embodiment, the method of the present embodiment was evaluated to be 1.2 times or more excellent in any element. In particular, there was a significant difference in items of space understanding, operation plan, and anxiety. Since the method of the present embodiment is easy to understand the space, it is easy to predict the flight operation planning, and since the surrounding situation can be understood, it has been shown that the method of the present embodiments allows the pilot to pilot the drone without anxiety even when the drone moves at high speeds.

### [5-3. Conclusion]

In both the Nose-in-Circle task and the fast-positioning task, the result that the method of the present embodiment is the most excellent in performance and the load is small was obtained.

The method of the present embodiment can be said to be a system that has reached SA level 3, which is a state in which the state around the airframe can be predicted, due to the following facts that the SA level 2, which is a state in which the state around the airframe can be understood, is satisfied because the error is low even in the Nose-in-Circle task, and the task success rate is almost 100% even in the fast-positioning task.

### 6. Effects

(1) The drone system 100 according to the present embodiment includes the main drone 10 including the camera 11, the sub-drone 20 including the camera 21 that captures an image of the main drone 10 from a bird's-eye view, and the controller 30 that controls the main drone 10 and the sub-drone 20. The controller 30 includes the display device 35 that displays a bird's-eye view image captured by the camera 21, and has a function of displaying the circular marker 41 indicating a distance from the main drone 10 within the bird's-eye view image.

By displaying the bird's-eye view image obtained by capturing the main drone 10 from the bird's-eye view, a pilot can confirm blind spots around the main drone 10. Furthermore, since distance information is visualized in the bird's-eye view image by the circular marker 41, which has been difficult, the future position and situation of the main drone 10 can be easily predicted. Therefore, highly accurate work can be performed by the main drone 10. In addition, even in a situation such as beyond visual line of sight flight, since the situation of the main drone 10 can be known from the information of the bird's-eye view image, work can be performed safely and accurately.
(2) The controller 30 may have a function of further displaying the triangular marker 42 indicating an orientation of the main drone 10 within the bird's-eye view image.

By visualizing the orientation of the main drone 10 with the triangular marker 42, the target direction of the drone can be easily grasped. In particular, in a task of performing aerial photographing while following a moving object, since the orientation of the camera 11 and the traveling direction of the drone are often different, the pilot is less likely to notice an obstacle or the like in the traveling direction of the main drone 10. However, since the display of the triangular marker 42 attracts attention of the pilot to the traveling direction of the main drone 10, the risk that the main drone 10 comes into contact with or collides with an obstacle or the like is reduced.
(3) The controller 30 may have a function of further displaying the frustum marker 43 indicating an area imaged by the camera 11 within the bird's-eye view image. Since the area imaged by the camera 11 is visualized by the frustum marker 43, the pilot can easily capture an object to be imaged by the main drone 10, and thus can accurately execute a task in a task in which a first-person viewpoint is important, such as aerial photographing and inspection. In addition, by displaying the frustum marker, it is easy to take correspondence between the bird's-eye view image and the area image.
(4) By converting the pixel coordinates of the main drone 10 appearing in the bird's-eye view image into the real-world coordinates, the position calculation unit 31b of the controller 30 does not cause a delay in update as in the case of using the GPS coordinates, does not cause a large error, and can provide highly accurate coordinates, distances, and the like.
(5) The controller 30 further includes the optimization unit 31a that controls the angle θ_{f}(t) and the target relative angle φ_{f}(t) of the camera 21 by moving the sub-drone 20 to a three-dimensional target position where the sub-drone is arranged on the conditions that the main drone 10 falls within the bird's-eye view image, an area imaged by the camera 11 falls within the bird's-eye view image, and a range in which the main drone 10 travels for a predetermined time falls within the bird's-eye view image.

By moving the sub-drone 20 to the three-dimensional target position so as to satisfy the above conditions (A) to (C), the optimization unit 31a can accurately grasp the situation of the main drone 10, and can always display various types of information in the bird's-eye view image.
(6) The optimization unit 31a determines a three-dimensional target position at which the sub-drone 20 is arranged, an angle of the second imaging device, and the target relative angle by using a primal-dual interior point method based on the three-dimensional positions of the main drone 10 and the sub-drone 20, the angle θ_{f}(t) of the camera 21 of the sub-drone, and the target relative angle φ_{f}(t), and performs control by using the cascade PID.

The sub-drone 20 can be controlled more accurately by performing optimization by the primal-dual interior point method and calculating the control amount by the cascade PID.
(7) The controller 30 calculates coordinates x, y on the plane of the main drone 10 with respect to the sub-drone 20 of the main drone 10 by using the angle φ of the sub-drone 20 relative to the perpendicular line AC of the camera 21, the vertical viewing angle θ_{fvfov} of the camera 21, and the altitude difference Alt between the main drone 10 and the sub-drone 20. Since the perpendicular line AC of the camera 21, the vertical viewing angle θ_{fvfov} of the camera 21, and the altitude difference Alt between the main drone 10 and the sub-drone 20 can be easily acquired from the values of the camera 21 and the sensor 22, respectively, the coordinates x, y on the plane of the main drone 10 with respect to the sub-drone 20 of the main drone 10 can be easily calculated only by calculating the angle φ relative to the perpendicular line AC of the camera 21 of the sub-drone 20.
(8) The main drone 10, the sub-drone 20, and the controller 30 include the communication devices 13, 23, and 34.

The communication device 13 of the main drone 10 transmits information (area image) of the area imaged by the camera 11 and the orientation, altitude, and speed of the main drone to the IF unit 34 of the controller 30. The communication device 23 of the sub-drone 20 transmits the bird's-eye view image, the inclination of the camera 21 of the sub-drone 20 (the angle of the focal field direction), and the orientation and altitude of the sub-drone 20 to the IF unit 34 of the controller 30. The IF unit 34 of the controller 30 transmits, to the communication devices 13 and 23 of the main drone 10 and the sub-drone 20, a signal for controlling the main drone 10 to fall within in the bird's-eye view imaged by the camera 21 of the sub-drone 20.

The main drone 10 and the sub-drone 20 transmit various pieces of the information to the controller 30, so that the position calculation unit 31b of the controller 30 can calculate the horizontal distance x, y between the main drone 10 and the sub-drone 20, the marker generation unit 31c can display the marker in the bird's-eye view image, and the optimization unit 31a can calculate the optimal position of the sub-drone 20.

In addition, the controller 30 transmits the control signal to the main drone 10 and the sub-drone 20, and the sub-drone 20 moves to the optimal position, thereby making it possible to capture an appropriate bird's-eye view image according to the speed of the main drone 10.

### 7. Modifications

As a scene where further control needs to be performed in addition to the above control, a state is assumed in which the main drone 10 gets under something or enters a blind spot of the sub-drone 20 due to some obstacle. In the method of the present embodiment, since the arrangement position is determined using the optimization function, such a problem can also be addressed by introducing a term corresponding to concealment of the main drone 10 and avoidance of the obstacle by the sub-drone 20 into a constraint condition and an objective function of the optimization function.

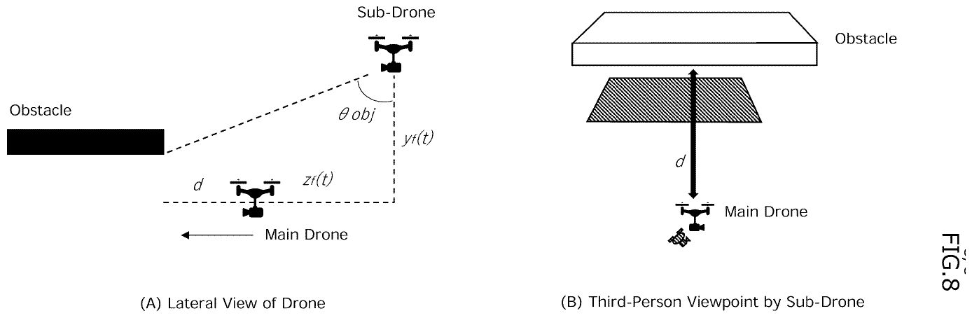

FIG. 8 is a diagram illustrating a positional relationship between a drone and an obstacle. (a) is a view of the drone viewed in the lateral direction, and (b) is a view of a third-person viewpoint by the sub-drone.

The following Equation 10 is added to the constraint condition in the section of the optimization method described above.

$${y}_{f} ( t ) tan ( {θ}_{obj} ) - {z}_{f} ( t ) \leq 1.5 min ( {v}_{z} ( t ) , 0 ) \qquad ( Equation 10 )$$

Here, θ_{obj}(t) represents an angle formed by a direction in which an obstacle is present with respect to the sub-drone with respect to a vertical direction of the sub-drone at time t, and v_{z}(t) represents the speed of the sub-drone in the Z-axis direction at time t.

Equation 10 means that the sub-drone is not arranged at a position where the main drone is physically invisible. This constraint enables the sub-drone to perform processing of changing the inclination and distance of the camera of the sub-drone within a range in which the main drone can be physically seen.

In consideration of the above constraint conditions, Equation 1 can be rewritten as the following Equations 11 and 12.

$${min}_{P ( t ) , {θ}_{f} ( t ) , {θ}_{f} ( t )} [ {w}_{1} {‖ P ( t ) - P ( t - 1 ) ‖}^{2} + {w}_{2} {{ϕ}_{f} ( t )}^{2} + {{w}_{3} ( {θ}_{f} ( t ) - {θ}_{{f}_{init}} )}^{2} + {w}_{4} {‖ P ( t ) - {P}_{init} ‖}^{2} + \frac{{w}_{5}}{{‖ P ( t ) - {P}_{obj} ( t ) ‖}^{2}} ] \qquad ( Equation 11 )$$

$${z}_{f} ( t ) < {z}_{obj} ( t ) \qquad ( Equation 12 )$$

Here, P_{obj}(t) represents three-dimensional position coordinates of the obstacle with the main drone 10 as an origin, and Z_{obj}(t) represents a distance (d) from the main drone 10 in the z direction from the obstacle.

In Equation 11, since the last term 5 increases when the drone approaches the obstacle, the position of the sub-drone 20 can be controlled to move to a position where the sub-drone 20 does not collide with the obstacle. Equation 12 is a constraint condition that no obstacle is intervened between the sub-drone and the main drone.

The above-mentioned extension Equations 11 and 12 enable the sub-drone to capture the main drone in a third-person viewpoint within a designated range while avoiding an obstacle.

In addition, since there is a possibility that the main drone 10 and the sub-drone 20 collide with an obstacle during piloting, the optimization unit 31a may be controlled so that the main drone 10 and the sub-drone 20 can avoid the obstacle using a program for automatically avoiding an existing obstacle.

According to the method according to the modification, the controller 30 can control the sub-drone 20 so that no obstacle is intervened between the main drone 10 and the sub-drone 20 by using Equations 11 and 12.

### 8. Others

The type and shape of the marker described above are merely examples, and are not limited to those described above. For example, a marker indicating a specific object that needs to be provided for space recognition may be added.

In addition, the sub-drone 20 may be further used as a relay station. As a result, the range of a cruising distance by a radio wave of the main drone 10 can be expanded.

In the present embodiment, two drones are used, but a plurality of drones may be used to generate and display a three-dimensional image by combining images captured by a group of drones. This can further improve the recognition of the surrounding space of the main drone 10 of the pilot.

The main drone 10 and the sub-drone 20 can be replaced alternately. As a result, desired imaging can be performed according to the environment. In this case, the cameras, the sensors, and the communication devices of the drones 10 and 20 in the above embodiment may have common specifications, and the control device may have both control functions of the main drone and the sub-drone. As a result, the above effect can be obtained while the components are commonized. It is noted that, at the time of communication with the controller 30, a communication code is changed at the time of replacement of the drone, and the replacement of the drone is notified to the controller 30. In this manner, the configuration and function of the controller do not need to be changed.

In the present embodiment, the display device 35 has a monitor shape as an example, but is not limited thereto, and may be, for example, AR glasses or the like.

All examples and conditional language recited herein are intended for the pedagogical purposes of aiding the reader in understanding the disclosure and the concepts contributed by the inventor to further the art, and are not to be construed limitations to such specifically recited examples and conditions, nor does the organization of such examples in the specification relate to a showing of the superiority and inferiority of the disclosure. Although one or more embodiments of the present disclosures have been described in detail, it should be understood that the various changes, substitutions, and alterations could be made hereto without departing from the spirit and scope of the disclosure.

What is claimed is:

1. A drone system comprising:
a main drone including a first imaging device;
a sub-drone including a second imaging device configured to capture an image of the main drone from a bird's-eye view; and
a controller configured to control the main drone and the sub-drone,
the controller comprising:
a memory;
a display device configured to display a bird's-eye view image captured by the second imaging device; and
processor circuitry coupled to the memory and configured to display, within the bird's-eye view image, a first marker indicating a distance from the main drone.

2. The drone system according to claim 1, wherein
the processor circuitry is further configured to display, within the bird's-eye view image, a second marker indicating an orientation of the main drone.

3. The drone system according to claim 1, wherein
the processor circuitry is further configured to display, within the bird's-eye view image, a third marker indicating an area imaged by the first imaging device.

4. The drone system according to claim 1, wherein
the processor circuitry converts pixel coordinates of the main drone appearing within the bird's-eye view image into real-world coordinates.

5. The drone system according to claim 1, wherein
the processor circuitry is further configured to control an angle of the second imaging device and a target relative angle by moving the sub-drone to a three-dimensional target position at which the sub-drone is arranged under conditions that the main drone falls within the bird's-eye view image, an area imaged by the first imaging device falls within the bird's-eye view image, and a range within which the main drone travels for a predetermined time falls within the bird's-eye view image.

6. The drone system according to claim 5, wherein
the processor circuitry is configured to determine the three-dimensional target position at which the sub-drone is arranged, the angle of the second imaging device, and the target relative angle by using a primal-dual interior point method based on a three-dimensional position of each of the main drone and the sub-drone, the angle of the second imaging device of the sub-drone, and the target relative angle, and to perform control by using a cascade PID.

7. The drone system according to claim 1, wherein
the processor circuitry is configured to calculate a relative distance between the main drone and the sub-drone by using an angle relative to a perpendicular line of the second imaging device of the sub-drone, a viewing angle of the second imaging device, and an altitude difference between the main drone and the sub-drone.

8. The drone system according to claim 1, wherein:
the main drone, the sub-drone, and the controller each include a communication device,
the communication device of the main drone transmits, to the communication device of the controller, information on an area imaged by the first imaging device and an orientation, an altitude, and a speed of the main drone,
the communication device of the sub-drone transmits, to the communication device of the controller, the bird's-eye view image, an inclination of the second imaging device of the sub-drone, and an orientation and an altitude of the sub-drone, and
the communication device of the controller transmits, to the communication device of each of the main drone and the sub-drone, a signal to perform control such that the main drone falls within the bird's-eye view imaged by the second imaging device of the sub-drone.

9. The drone system according to claim 1, wherein
the processor circuitry is configured to perform control such that an obstacle is not intervened between the main drone and the sub-drone.

10. A non-transitory computer-readable recording medium having stored therein a drone control program causing a computer provided in a controller configured to control a main drone including a first imaging device and a sub-drone including a second imaging device configured to capture an image of the main drone from a bird's-eye view to execute:
displaying, on a display device, a bird's-eye view image captured by the second imaging device, and
displaying, on the display device, a first marker indicating a distance from the main drone within the bird's-eye view image.

11. A drone control method of causing a computer provided in a controller configured to control a main drone including a first imaging device and a sub-drone including a second imaging device configured to capture an image of the main drone from a bird's-eye view to execute:
displaying, on a display device, a bird's-eye view image captured by the second imaging device, and
displaying, on the display device, a first marker indicating a distance from the main drone within the bird's-eye view image.
